(19) United States
(12) Patent Application Publication
(10) Pub. No.: US 2004/0103729 A1
(43) Pub. Date: Jun. 3, 2004

(54) Dual-axis centrifugal propulsion system

(76) Inventors: Roger Dean Strickler, Mammoth, PA (US); Suzy Strickler, Mammoth, PA (US)

Correspondence Address: BACON & THOMAS, PLLC, 625 SLATERS LANE, FOURTH FLOOR, ALEXANDRIA, VA, 22314

(21) Appl. No.: 10/306,167

(22) Filed: Nov. 29, 2002

(51) Int. Cl. F16H 27/04

(52) U.S. Cl. 74/84 S

(57) ABSTRACT

A fixed radius rotating mass having a first axis of rotation is arranged to also rotate about a second axis at 90° relative to the first axis, and at the same speed, to provide a net unidirectional force generator that requires little energy input. This reduces consumption of fossil fuels and resultant global pollution and global warming. It also allows for a simple means of levitating a vehicle, lower lift off mass for space missions and more efficient space travel propulsion.

### BACKGROUND OF THE INVENTION

1. Field of the Invention

This invention relates to a vehicle propulsion system, and in particular to a propulsion system that utilizes centrifugal force to propel a vehicle.

The propulsion system of the invention offers energy savings of up to 80%, with consequent decreases in pollution.

2. Description of Related Art

2A. Brief Explanation of the Principles of the Invention

This explanation of the invention is qualitative in nature. A more formal mathematical explanation is found in the “Detailed Description” portion of this specification.

FIG. 1A shows a first mass M1 connected to a second rotating mass M2. The rotating second mass M2 exerts a pulling force F₁ that causes the first mass M1 to be pulled in the direction of second mass M2. In the absence of friction or air resistance, mass M2 will continue to rotate at a constant angular velocity and force F₁ will constantly pull mass M2 in the direction of mass M1. If a torque is applied to increase the angular velocity of mass M2, force F₁ will increase proportionally.

The relative power of the centrifugal pulling force thus generated is evidenced by the Olympic hammer toss, in which a weight on a chain is swung by the athlete and then relates, causing the centrifugal force to propel the “hammer” far further than is possible if the weight is simply thrown. The reason is that the athlete is able to apply a constant torque for an extended period, thereby increasing the momentum of the weight to a far greater extent than is possible during the short arc of a conventional throw.

A conventional propulsion system also converts torque into propulsive force, but it does so in a manner that is far less efficient than releasing the hammer. When the hammer is released, all of the momentum is transferred to the weight. On the other hand, when a motor propels a land vehicle, by way of example, the torque must be transferred to wheels of the vehicle, which in turn push against the road surface to propel the vehicle. Pushing against the road surface causes equal and opposite forces to be generated, with the opposite force propelling the vehicle. As shown in FIG. 2, the momentum m₁v₁ of the vehicle is matched by the momentum m₂v₂ transferred to the earth according to the principle of conservation of momentum. As a result, only a portion of the torque generated by the motor is converted into a propulsion force.

The energy losses resulting from Newton's third law apply to ships, aircraft, and space vehicles as well as to land vehicles. In order to propel the vehicle forward, the vehicle must push against an external mass, and therefore energy is lost to the external mass. In the case of a rocket, the external mass is the exhaust emitted by the rocket, which must be carried by the rocket until emission, further increasing the necessary propulsive force.

In contrast, in the rotating mass system of FIG. 1, all of the instantaneous force acting on mass M1 is in one direction. If this force could be used as a propulsive force, the resulting propulsion system would be far more efficient than the conventional propulsion system described above. In addition to losses to the external mass, the conventional propulsion system suffers from losses due to friction in the drive train of a land or sea vehicle, and due to the weight of the propellant in the case of a space ship.

But of course, a propulsion system based solely on centrifugal force, as shown in FIGS. 1A and 1B, is impossible. The reason is that centrifugal force is maintained only so long as mass M2 rotates. While mass M2 exerts a strong force in the direction shown in FIG. 1A that will cause mass M1 to move in the direction of mass M2 if it is not secured to a much larger mass such as the earth, the direction of force F1 is constantly changing so that movement in direction F1 is eventually countered by movement in the direction of an opposite force F2 as the mass reaches the opposite side of its orbit, as shown in FIG. 1B. Thus centrifugal force F1 cannot be used as a propulsion system, at least as illustrated in FIGS. 1A and 1B.

It turns out, however, that centrifugal force can be used as a propulsion system by making a simple modification to the system shown in FIGS. 1A and 1B. To understand this modification, consider a revolving globe, as shown in FIGS. 3A and 3B. After half a rotation around the north-south axis, a point M that starts on the west side, as shown in FIG. 3A, will move from west to east and be on the east side, as shown in FIG. 3B. If the globe is flipped over at that time, the point will move in the opposite direction, from east to west rather than west to east. Furthermore, if the globe is rotated constantly around an axis through the equator at the same time that it rotates around the north-south axis, a point M that starts out moving west to east will still reverse direction and move east to west after half a rotation. Because the north and south poles of this “double rotating” system always “flip” after half a rotation, between the positions shown in FIGS. 3A and 3B, the point M will always be in one hemisphere.

If point M is replaced by a mass M connected to another mass at the center of the globe, then the centrifugal force exerted by the mass M on the second mass at the center of the “globe” will always be directed to the hemisphere in which the mass moves. A net unidirectional force will thus be generated. This net unidirectional force will have all of the characteristics of the centrifugal force of FIGS. 1A and 1B, and yet can be used as a propulsive force in any vehicle. It is a pure “pulling” force that does not require the vehicle to push against an external object or mass, and thus can in theory be used to levitate or fly a vehicle, without the need for wings, as easily as it can move a vehicle along the ground, and far more efficiently than conventional propulsion systems. In fact, a working model of just such a levitating system has been built and tested by the inventor, as described below.

It might be wondered why a two-axis centrifugal force generating system of this type has not previously been discovered. The physics underlying the invention has been quantitatively well known since the seventeenth century, and intuitively understood far earlier. The advantages of the invention immediately follow from these equations, which are described below, and the equations do not need to be modified to be applied to the invention. All that is needed is to add the force vectors generated by the centrifugal force equation in three dimensions, to account for the double rotation. Perhaps the answer is simply that propulsion has always involved pushing against something, and therefore we have been genetically predisposed to believe that propulsion without pushing against something is impossible. Until now.

2B. A Prior Centrifugal Force Based System

One prior patent, U.S. Pat. No. 3,555,915 (Young) purports to disclose a centrifugal force based propulsion system. However, the system disclosed by Young, which is illustrated in FIG. 4, does not work.

In the Young system, as illustrated in FIG. 4, two masses are situated at different radii on a spinning wheel. According to Young, an unbalance force is created from the position of the two masses to cause propulsion. However, as in the example of FIGS. 1A and 1B, even though the masses are at different radii on the spinning wheel, they experience the same spinning wheel centrifugal force, and there is no net force for propulsion. The two masses are only at different angles because of the velocity of precession. Because of the arm rotation and wheel rotation, when the upper mass experiences near zero absolute arm radial velocity (the vector sum of the arm velocity and wheel velocity is near zero) while the lower mass is experiencing full absolute arm radial velocity (the vector sum of the arm velocity and wheel velocity in near doubled), so that the wheel accelerations are equal.

2C. Jackhammer-Type Systems

A number of patents describe systems that seek to use a mass for propelling another mass, and thereby keep energy from being lost to an external mass. These systems all use a “jackhammer” or “pile driver” principle in which a mass is impacted or slowed down to the vehicle in a two dimensional framework to produce propulsion in the same way that a jackhammer utilizes a mass for impact force, the mass then being recovered to repeat the cycle. Examples are disclosed in U.S. Pat. Nos. 4,674,583 (Peppiatt) 5,685,196 (Foster), and 4,770,063 (Mundo).

In such devices, the maximum energy imparted to the vehicle can be no more than the kinetic energy of the mass that impacts with it, and is usually significantly less. The energy added to the vehicle has to be made up by adding energy back to the impact mass. As such, a large carry on power source must be available to realize a propulsion drive of this type.

2D. Other Propulsion Systems

All other known or previously proposed propulsion systems of which the Inventor is aware, with the exception of those that rely on an external force such as wind power, utilize pushing forces. In addition to manual and motor powered vehicles and watercraft, vehicles that use pushing forces include propeller and jet aircraft, and the Space Shuttle. Interesting examples of less well-known types of propulsion systems that purport to improve the efficiency of conventional systems, but nevertheless rely on “pushing-mass physics” with the inherent disadvantages noted above, include plasma rockets, cyclotron ion engines, and impulse magnetoplasma systems, and nuclear thermal systems, disclosed respectively in U.S. Pat. Nos. 4,815,279 (Chang), 5,241,244 (Cirri), 6,334,302 (Chang-Diaz), 6,367,243 (Schmidt). Neither the centrifugal force system of Young, the jackhammer-type systems described above, nor the “push apart mass” systems involves use of a fixed radius mass rotating in three dimensions and attached to and propelling a secondary mass in the form of a vehicle by centripetal/centrifugal force.

### SUMMARY OF THE INVENTION

It is accordingly a first objective of the invention to provide a propulsion system that utilizes centrifugal, pulling forces rather than push apart forces to propel a vehicle, and that therefore does not lose any energy to an object being pushed against.

It is a second objective of the invention to provide a force generator that can be used in a propulsion system, and that provides energy savings approaching 80% relative to existing sources of propulsion energy, reducing consumption of fossil fuels and the resulting global pollution and warming.

It is a third objective of the invention to provide a propulsion system in which the propulsive force is proportional to the square of the rotational speed irrespective of vehicle velocity.

It is a fourth objective of the invention to provide a propulsion system for a land or water vehicle that does not require a drive train, transmission, differential, or other connection to wheels or propellers.

It is a fifth objective of the invention to provide a propulsion system for a space vehicle that does not require expulsion of burnt fuel or other materials, and that therefore allows for lower lift off mass for space missions.

It is a sixth objective of the invention to provide a simple means of both propelling and levitating a vehicle.

It is a seventh objective of the invention to provide a simple and inexpensive propulsion system that can be used in a wide variety of different types of vehicles.

It is an eighth objective of the invention to provide a double-rotating-mass centrifugal propulsion system that minimizes inherent vibrations resulting from components of the force that are not in the direction of propulsion.

These objectives are achieved by providing a propulsion system made up of a fixed radius rotating mass that in turn rotates at an identical period of rotation about a second axis 90° with respect to the first axis of rotation, thereby providing a smooth unidirectional force generator that requires little energy input.

Since the net propulsive force resulting from double rotation of the mass, i.e., rotating the mass at identical rates around two perpendicular axes, is a centrifugal force, any object connected to center of rotation of the mass will be pulled in the direction of the net force. All that is needed is for the mass to be “double rotated” in the above-described manner, and connected to the object to be propelled. The mass does not need to be connected-to, or react against any other object or mass, as in a conventional propulsion system that relies on equal-and-opposite pushing, rather than pulling, forces.

Place the double rotating mass in the engine compartment of a car, and the car will be propelled forward, without having to push against the ground, and without the need for a drive train. Furthermore, point the net unidirectional force vector in an upward direction, and the vehicle will be pulled up, i.e., it will levitate or fly. Similarly, a ship will move without pushing against water, plane will move without pushing against air, and a rocket will move without the need to expel exhaust.

Because the propulsion system of the invention does not push against the earth, water, air, or the exhaust of a rocket ship, no energy is transferred to the earth, water, and so forth. Whereas a conventional propulsion system that pushes against the earth, for example, transfers half the momentum to the earth (which fails to noticeably move only because of the typically extremely large mass ratio between the earth and the vehicle), the system of the invention transfers momentum from the rotating mass only to the vehicle, without any losses to external masses.

Finally, it will be appreciated that if the force generator of the invention is placed at the end of a torque arm so as to cause rotation of the torque arm, a constant torque applied to the double-rotating mass of the force generator will cause the torque arm to output a constantly increasing power with respect to torque arm rotational speed, with the result that it might be possible to generate more energy, for example in the form of electricity, than is input.

### BRIEF DESCRIPTION OF THE DRAWINGS

FIGS. 1A and 1B are schematic diagrams of a conventional two-dimensional centrifugal force generating system.

FIG. 2 is a schematic diagram of a conventional “pushing force” based propulsion system.

FIGS. 3A and 3B are schematic diagrams illustrating the principle of two-axis motion.

FIG. 4 is a schematic diagram of the centrifugal force propulsion system disclosed in U.S. Pat. No. 3,555,915 (Young).

FIG. 5 is a graph illustrating the relationship between force and velocity in a conventional propulsion system.

FIG. 6 is a schematic diagram illustrating the forces involved in a conventional propulsion system.

FIG. 7 includes schematic illustrations of various vehicles that might use the centrifugal force based “impulse drive” of the invention.

FIGS. 8-10 are vector diagrams illustrating in greater detail the forces underlying the centrifugal force system of FIGS. 1A and 1B.

FIG. 11 is a graph illustrating the instantaneous forces on a mass during one revolution of the two-dimensional system of FIGS. 8-10.

FIG. 12 is a schematic diagram illustrating an electrical analog of the force generator of the invention.

FIG. 13 is a graph illustrating the total “impulse” forces generated by the system of FIGS. 8-10.

FIG. 14 is a plot showing the path followed by a double-rotating mass according to the principles of the invention.

FIG. 15 is a graph showing the instantaneous centrifugal forces in the two planes of rotation of the double-rotating mass system of the invention.

FIG. 16 is a graph showing the net forces generated by the double-rotating mass system of the invention in the direction of propulsion.

FIG. 17 is a graph comparing force and velocity curves for the conventional vehicle of FIG. 5 and one that uses the propulsion system of the invention.

FIG. 18 is a graph showing power and torque curves for a test version of the propulsion system of the invention.

FIG. 19 is a graph comparing force and horsepower curves for a conventional vehicle and one that uses the propulsion system of the invention.

FIG. 20 is a graph showing the effect of the spin mass-to-vehicle mass on drive acceleration and required orbital velocity.

FIG. 21 is a cross-sectional view of a single assembly of a double rotating mass system that uses gearing to achieve the double rotation, according to an actual implementation of the invention.

FIG. 22 is a plot of the orbit followed by the mass in the implementation of FIG. 21.

FIG. 23 is a schematic diagram illustrating the use of four double rotating mass systems to minimize vibrations according to a preferred embodiment of the invention.

FIG. 24 is a vector diagram of the preferred embodiment of FIG. 23.

FIG. 25 is a plot of the preferred embodiment of FIG. 23, in which the orbits are phased to provide zero impulse force.

FIG. 26 is a schematic diagram of a two motor embodiment of the invention.

### DETAILED DESCRIPTION OF THE PREFERRED EMBODIMENTS

a. Detailed Explanation of Principles of Invention

The following is a review of basic principles of motion that may be helpful in quantitatively understanding the invention. The actual invention is discussed below in connection with FIGS. 14 et seq.

“Work” results when a force acts on a mass through some distance, and is defined by the well-known equation:

Work=Force×Distance. a.

For example, if a 100 lb force is applied steadily to move an object a distance of 10 feet, then 1000 ft-lbs of work is performed. The resulting increase in velocity of the mass to which the force is applied can be found based on the equivalence of “work” and “energy,” and from the well-known equation for energy:

Work Added=Energy Added=½M [V₂²−V₁²], b.

where M is the mass of the object, V₁ is the velocity of the object before work or energy is added, and V₂ is the velocity of the object after work or energy is added.

The amount of work or energy expended over an extended time interval is known as power. Power is often defined in horsepower. One horsepower is the work expended in applying 550 lb of force to move an object 1 ft in 1 sec., which may be expressed as follows:

Power (HP)×550 (ft-lb/sec.)×Time Interval(sec.)=Work or Energy. (3)

Combining equations 1 and 3, one obtains the following equation for power in terms of force and distance:

$$Power ( HP ) = \frac{Force ( lb ) \times Distance ( ft )}{Time Interval ( sec . ) \times 550 ( ft \text{-} lb \text{/} sec . )} . \qquad ( 4 )$$

The distance that the object travels in a period of time is the velocity, and therefore equation (4) can be expressed as follows:

$$Power ( HP ) = \frac{Force ( lb ) \times Velocity ( ft \text{/} sec . )}{Time Interval ( sec . ) \times 550 ( ft \text{-} lb \text{/} sec . )} . \qquad ( 5 )$$

In addition, equations (2) and (3) may be combined to yield:

$${V}_{2}^{2} - {V}_{1}^{2} = \frac{2 \times Power ( HP ) \times 550 ( ft \text{-} lb \text{/} sec . ) \times Time Interval ( sec . )}{M ( lbm )} . \qquad ( 6 )$$

Mass is conveniently expressed as weight divided by the force of gravity, and for the unique case where the mass starts with zero velocity (V₁=0), equation (6) yields the following equation:

$${V}_{2} ( ft \text{/} sec ) = \sqrt{\frac{2 \times Power ( HP ) \times 550 ( ft \text{-} lb \text{/} sec ) \times Time ( sec ) \times 32.2 ( ft \text{/} {sec}^{2} )}{Weight ( lb )}} \qquad ( 7 )$$

One can use equations 5 and 7 for a vehicle or mass producing constant horsepower for propulsion and look at the resulting force and velocity produced over time. Ignoring the effect of actual wind drag, friction, and terrain on the vehicle or mass, FIG. 5 shows how force and velocity change for a 2000 lb vehicle as it accelerates over time by producing a constant 20 HP by its drive train as measured at the tires. Of course, in the real situation where wind and drag and friction come into play, the vehicle would only reach a velocity where its propulsion force just matched or equaled the wind drag and friction.

The propulsion effect illustrated in FIG. 5 depends on the effect of two masses, one of which is the vehicle and the other is the ground or other mass that supports the vehicle, as illustrated in FIG. 6. The underlying physical law is Newton's definition of force as the product of mass and acceleration, F=M×A, which can conveniently be arranged as equation 8:

$$F ( lb ) = M \times A = \frac{Weight ( lb ) \times ⅆ V ( ft \text{/} sec )}{32.2 ( ft \text{/} {sec}^{2} ) \times ⅆ T ( sec )} . \qquad ( 8 )$$

As a result, for M₁ in FIG. 6, assuming both masses are initially at zero velocity:

$${V}_{1} = \frac{F ( lb ) \times T ( sec )}{{M}_{1}}$$

$$and$$

$${V}_{2} = \frac{F ( lb ) \times T ( sec )}{{M}_{2}} .$$

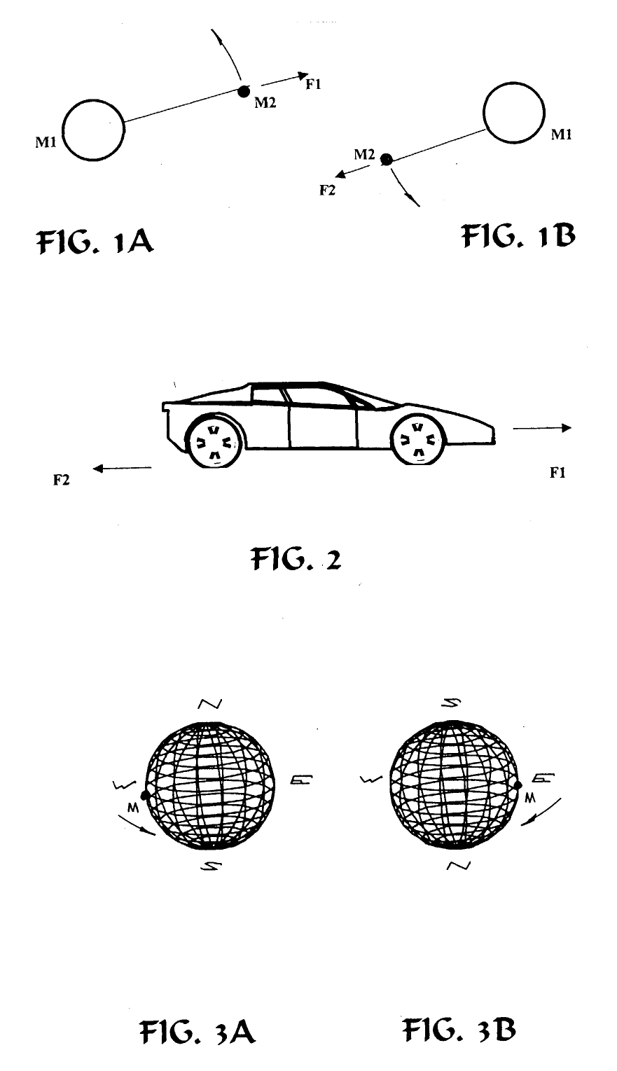

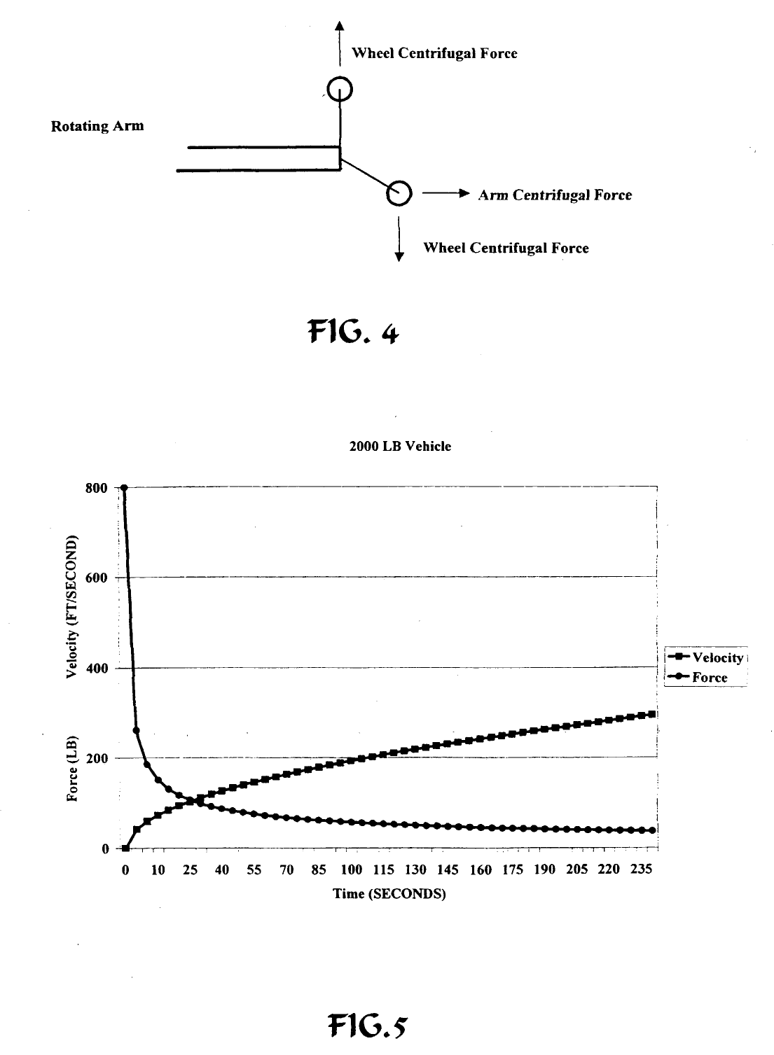

The forces are equal for both masses. Thus, for the vehicle in FIG. 1, the same force and energy applied to the car must also be applied to the earth. Of course, since the earth is so massive relative to the car, the net rotational velocity realized by the earth is effectively zero. This transfer of energy or momentum is the reason for the factor of ½ in equation 2, since ½ the total energy available is transferred to the earth's reactive mass.

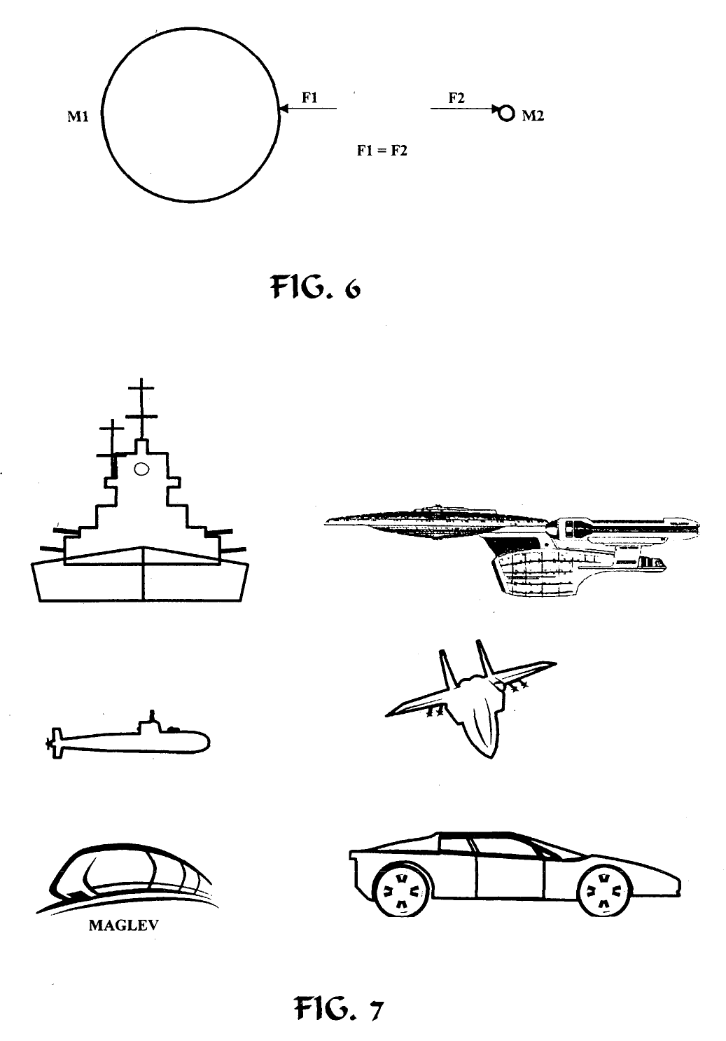

The practical effects of the fact that ½ of the total energy is transferred to the earth's reactive mass, although known since the Newton, has generally not been appreciated, at least as related to propulsion systems. It is usually assumed that the ½ factor is inherent in the equation for kinetic energy. However, Einstein realized that this is not the case in his E=MC² equation, where the mass of a particle times velocity squared without the ½ factor was indicative of a mass' absolute energy. The ½ factor appears to enter as a result of relativity between the two mass' or “push apart” physics, and is inherent only because most forms of propulsion to date use the “push apart” reaction shown in FIG. 6. All of the vehicles illustrated in FIG. 7, except the space ship, utilize “push apart” propulsion. A car pushes against the earth's surface; a ship pushes against the sea; a propeller plane, jet, or helicopter pushes against the air; a rocket or space shuttle pushes against the mass of expanded fuel gases that it carries with it allowing it to propel itself in the vacuum of space. In contrast, the space ship illustrated in FIG. 7 utilizes an “impulse engine” for normal propulsion, which could be the system of the present invention, since it would be extremely impractical to carry the fuel necessary for conventional rocket propulsion on an extended space mission.

While it is difficult to realize the force/energy reaction of the earth in a car, one realizes it is a boat as the jet stream of water is witnessed coming from the propeller. If one could see air, one would see the same effect from a plane's propeller or jet engine. One can definitely witness the hot expanded gases from the space shuttle's side mounted solid propellant boosters or from the hydrogen/oxygen burns of the center main ship's rocket engines.

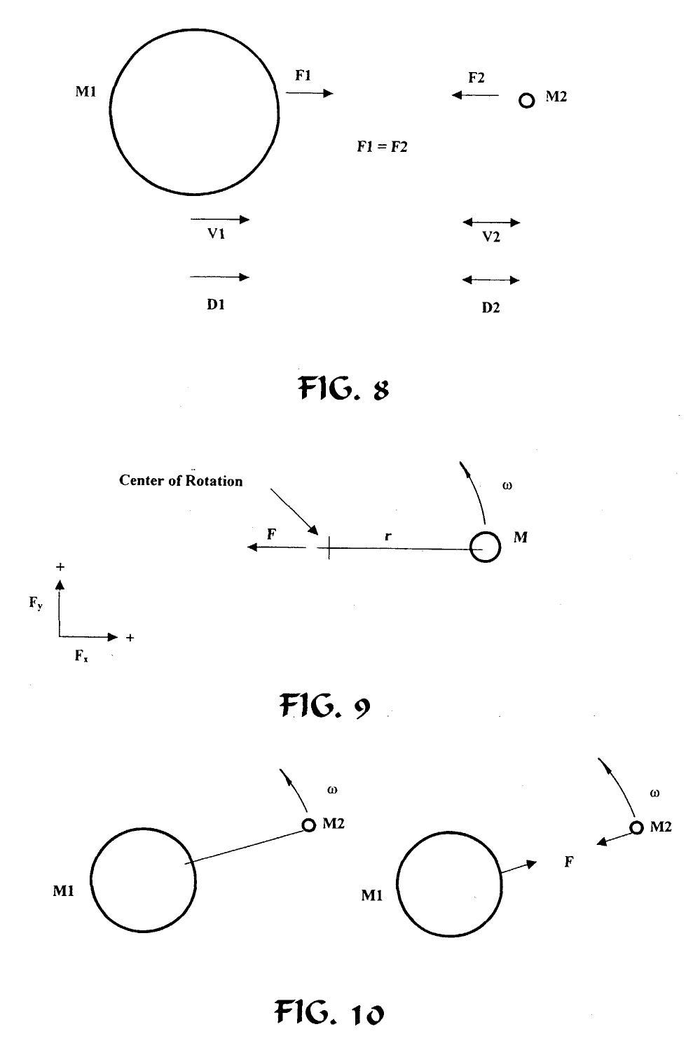

Instead of “pushing apart” like all present forms of propulsion, the vehicle of the invention “pulls together” the reacting mass M₂, carrying M₂ with it, resulting in the total energy being absorbed by the vehicle. The pulling force comes from centrifugal force, i.e., the pulling force that one feels when a mass is spun as shown in FIGS. 8 and 9, but overcomes the problem that the force is always balanced by an opposite force as the mass rotates.

The centrifugal force produced by the spinning mass is given by equation 9:

$$F ( lb ) = \frac{W ( lb ) \times r ( in )}{386.4 ( in \text{/} {sec}^{2} )} \times {( \frac{RPM \times 2 \times π}{60} )}^{2} \qquad ( 9 )$$

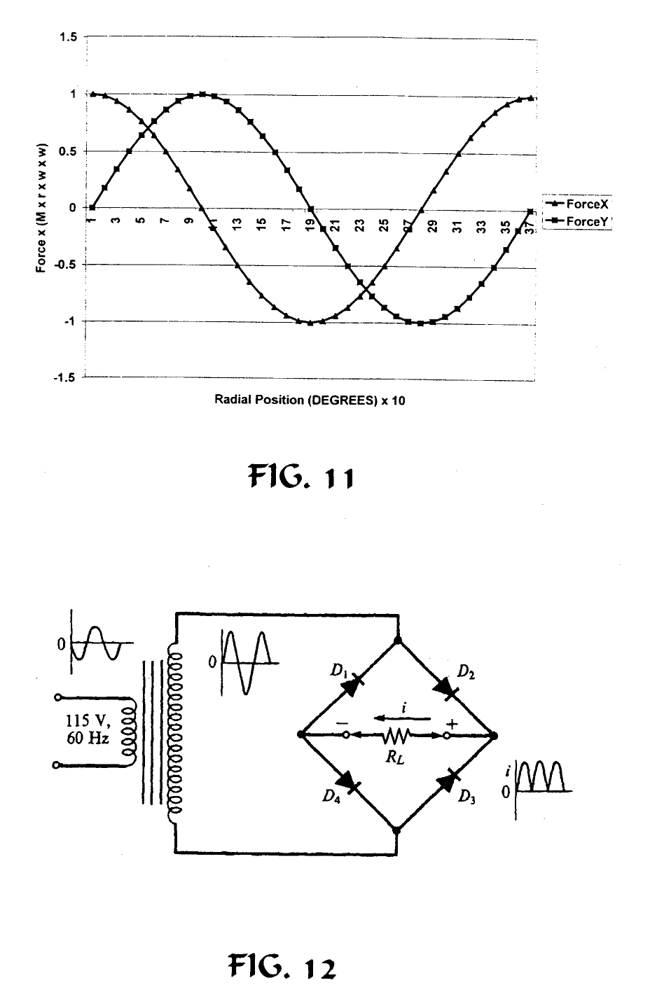

The free body diagram shown in FIG. 10 shows the desired pulling force generated by the spinning mass M₂. The problem is that the desired pulling force is also generated on the other side of M₁ when M₂ travels 180 degrees from the position illustrated in FIG. 10. The net travel or propulsion of M₁ and M₂ over time and rotation is still zero, with both masses simply vibrating and exchanging momentum. If one looks at the force in the X and Y directions over time as M₂ rotates, one sees the sinusoidal force waves shown in FIG. 11. What is needed is just half of the force cycle wave with respect to rotation.

This is analogous to AC voltage/current in electricity. AC voltage oscillates sinusoidally in the manner shown in FIG. 11. In fact, the force in a mechanical system is analogous to current in the electrical system, mass is analogous to capacitance, and velocity is analogous to electrical voltage. In electricity, as shown in FIG. 12, a diode bridge rectifier converts AC to DC (direct current) electricity. The rectifier may be a half wave or full wave converter depending on the number of diodes used. If a device could be made mechanically to rectify alternating force, the result would be a force rectifier that converts an alternating force to a unidirectional force/velocity just as a voltage rectifier converts alternating current/voltage to a unidirectional current/voltage.

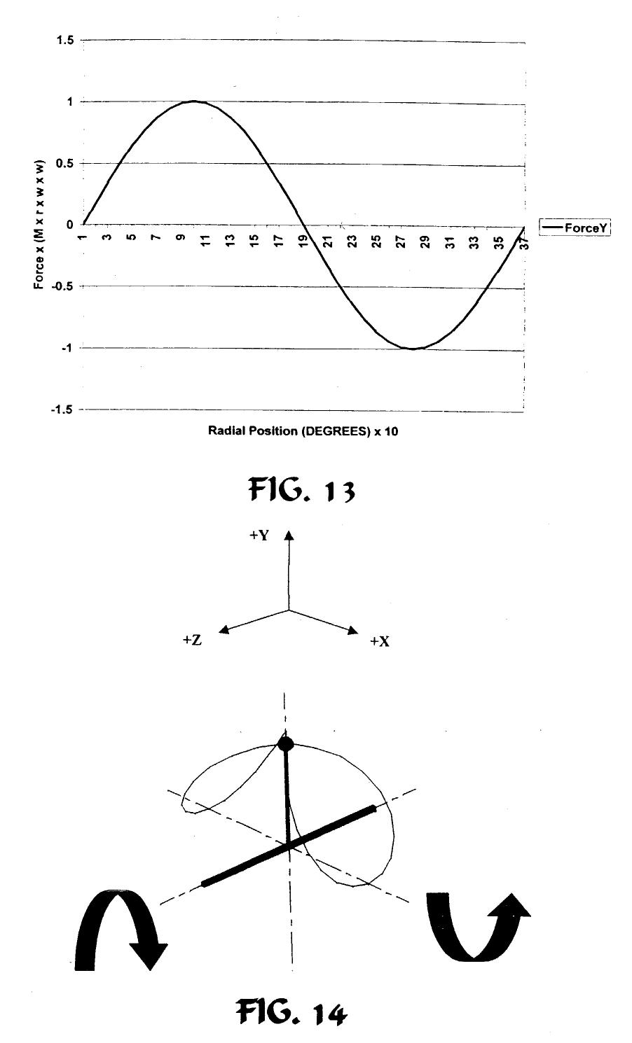

Nevertheless, no matter what combinations of mass and velocity in a two dimensional plane that one contrives, one will always end up with an alternating force like the one shown in FIG. 11. While such systems may not, as in the system of U.S. Pat. No. 3,555,915, discussed above, always have a constant amplitude or frequency, they will always have a balanced impulse over one cycle which is the product of force and time or the area under the curve as shown in FIG. 13.

Since force times time (impulse) equals mass times velocity (momentum), there is never any net gain in velocity of momentum of the mass M₁, which the spinning mass M₂ is attached to. The requirements of any propulsion system, on the other hand, are that the force/velocity must be unidirectional (constant direction), just as the voltage/current is unidirectional in the analogous electrical system of FIG. 12.

Although it is impossible to achieve a “force rectifier” in two dimensions, it is possible to achieve such a rectifier in three-dimensions. This is the basic principle of the present invention. When a mass is spun in three dimensions around two axes, it is possible to limit the motion of the mass to less than the available spherical surface by spinning the mass at the same speed (revolutions per second) around the two axes, so that the orbit or path is spent only in half of the available spherical surface as shown in FIG. 14, which shows the path of a mass rotating around the X and Z axes of a three-dimensional Cartesian coordinate system, with respective angular velocities ω₁ and ω₂ being equal to each other.

If one analyzes the equations of motion and centrifugal force of such an orbit, one arrives at the following equations 10, 11, and 12 from superposition of force vectors in the double rotating framework:

Fₓ=M₂×r×ω²×cos(ω×t); (10)

F_{y}=2×M₂×r×ω²×sin²(ω×t); (11)

and

F_{z}=2×M₂×r×ω²×sin(ω×t)×cos(ω×t). (12)

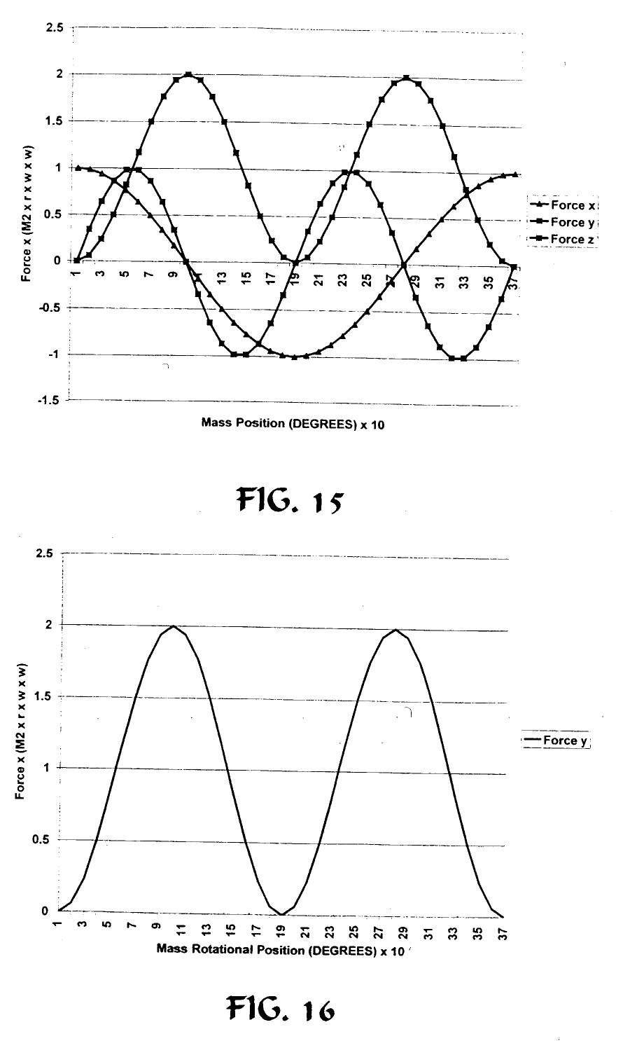

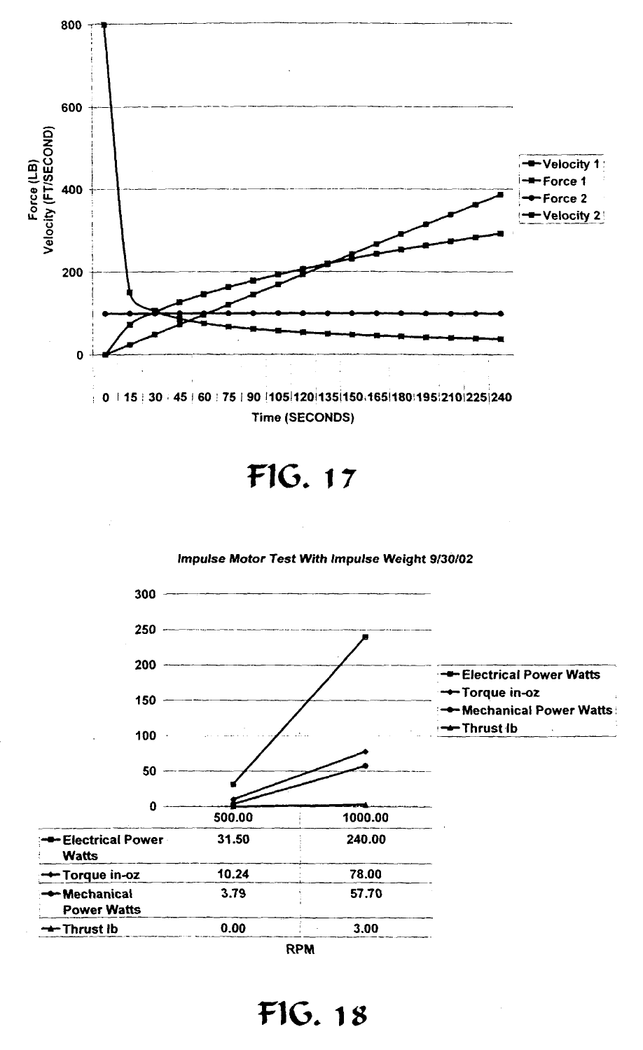

Plotting these force waves as a function of the mass's orbit, it can be seen in FIG. 15 that the force in the X and Z directions remains sinusoidal and “impulse balanced,” i.e., equal with no net gain. However, the force in the Y direction is always a positive or constant direction force, which is exactly the requirement for achieving a “force rectifier” or “impulse propulsion.” One only needs to subtract or cancel Fₓ and F_{y} with exactly opposite and equal force waves 180° out of phase, and one is left with F_{y}, the unidirectional propulsion force.

Equation 11, plotted in FIG. 16, can be integrated to obtain the average unidirectional force over time:

F_{y}average=M₂×r×ω², (13)

which is half the average peak force. From equation 8, the velocity of a vehicle subject to force F_{y} is:

$$V ( ft \text{/} sec ) = \frac{F ( lb ) \times t ( sec ) \times 32.2 ( ft \text{/} {sec}^{2} )}{W ( lb )} \qquad ( 14 )$$

Looking at the same vehicle described by the graph in FIG. 1, when the conventional engine is replaced by the double rotating mass of the invention, producing a constant force of 100 lb (average force per revolution), the velocity (velocity 2) increases linearly with the force pursuant to equation 14. Initially, the reaction force results in greater acceleration. However, the forces are equal at 34 seconds, and the velocities match each other at 136 seconds, after which the impulse propulsion system of the invention exceeds the conventional 20 HP push-apart propulsion power of the conventional engine of FIG. 5.

Equation 13 gives the amount of force required to produce a constant net force of 100 lb. For example, a 0.25 lb weight on a one inch radius spinning at 4000 RPM produces 113 lb of average force. Because of inertia, the only power required to drive a vehicle at constant speed is the power necessary to overcome bearing and windage losses.

b. Results Obtained With Test Module

The above-described principles have been tested by constructing a test module using a rough 28 pound unrefined design constrained to move vertically. The design did not cancel out the x and y components of the propulsive force. Nevertheless, application of just 57.7 Watts (0.077 HP) input of mechanical power to achieve the double rotation (equivalent to amount of power needed to light a 60 W light bulb) resulted in the production of 3 lbs of thrust at 1000 RPM. With this rough design, 2.57 HP of mechanical power at 1000 RPM will develop 100 lb of thrust, quickly exceeding a constant 20 HP of “push apart mass” propulsion.

It will be appreciated by those skilled in the art that even the rough test module described above achieves more output than input horsepower. This increase in horsepower does not violate conservation of energy principles since the concept of horsepower assumes a push-apart force, whereas with “pull together mass,” the impulse force is directed constantly to the vehicle mass that it is attached to, regardless of the vehicle's velocity. Since thrust increases with the square of spin speed, the Inventor believes that this rough model could achieve 100 lb of thrust before reaching stress limits near 4000 RPM.

Substituting equation 14 into equation 5 to look at developed horsepower of an impulse drive, one obtains equation 15:

$$Power ( HP ) = {Force}^{2} ( lb ) \times \frac{t ( sec ) \times 32.2 ( ft \text{/} {sec}^{2} )}{W ( lb ) \times 550 ( ft \text{-} lb \text{/} sec . )} . \qquad ( 15 )$$

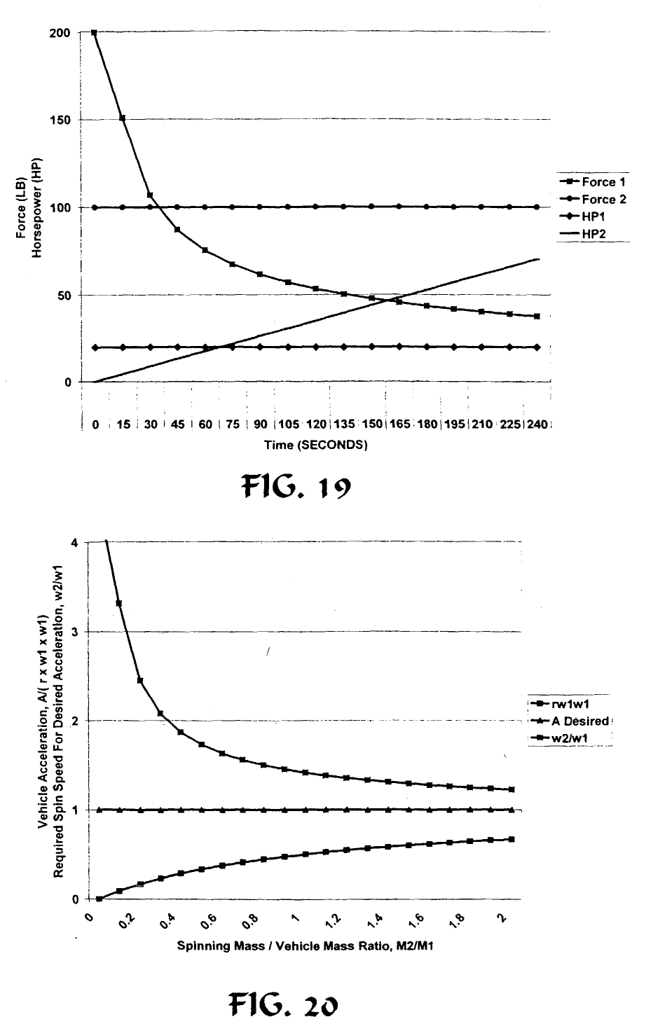

The effect of this equation, compared with the conventional horsepower equation (5) illustrated in FIG. 1, is shown in FIG. 19. Whereas the horsepower HP1 of the conventional engine stays constant with increasing velocity, the horsepower HP2 of the centrifugal or “pull-together” propulsion system of the invention increases continuously in the absence of resistive forces. When used in a spaceship, for example, the horsepower would increase forever with a constant impulse force, subject only to the effects of special relativity. For the example given in FIG. 14, HP2 is only 29 HP after 100 sec., but after one hour, HP2 has increased to 1054 HP as compared to a constant 20 HP “push apart mass” drive propulsion. The invention in effect renders the concept of horsepower, i.e., force multiplied by velocity, obsolete.

The spinning mass used for propulsion in the double-rotation “impulse” drive of the invention should be small enough to realize sufficient acceleration while keeping the mass ratio, M₂/M₁, as small as possible. The driving force or acceleration of M₂ is a function of M₁, which it is attached to, as defined by equation 16:

Driving Force=(M₂/M₂+M₁)×r×ω². (16)

FIG. 20 shows the effect of spin mass to vehicle mass ratio on the drive acceleration and the associated higher spin speed required for a desired acceleration based on this mass ratio. At a mass ratio of zero, no drive force or acceleration is realized because there is no vehicle mass. The higher the mass ratio, however, the lower speed required to achieve the desired acceleration.

One advantage of the centrifugal drive of the invention is that it can be installed in the same accommodations as personnel or cargo. For spacecraft, submarines, or any other vehicle operating in a pressure differential environment, this means that no penetration of the pressure hull is required for the vehicle to propel itself. This results in no leakage, no need for seals, and increased safety and reliability for the personnel. Also, because the propulsion system of the invention uses “pull together mass” physics, and never loses its reacting mass, there is no need for a large lift-off reacting mass for operation in a vacuum such as space travel.

In addition, it will be appreciated that because the device does not require something to push against, levitation is possible. In fact, significant force can be generated by a relatively small drive to develop several times the vehicle's weight or “G” force, limited only by the acceptable levels of stress of the materials used for construction.

c. Description of a Preferred Embodiment

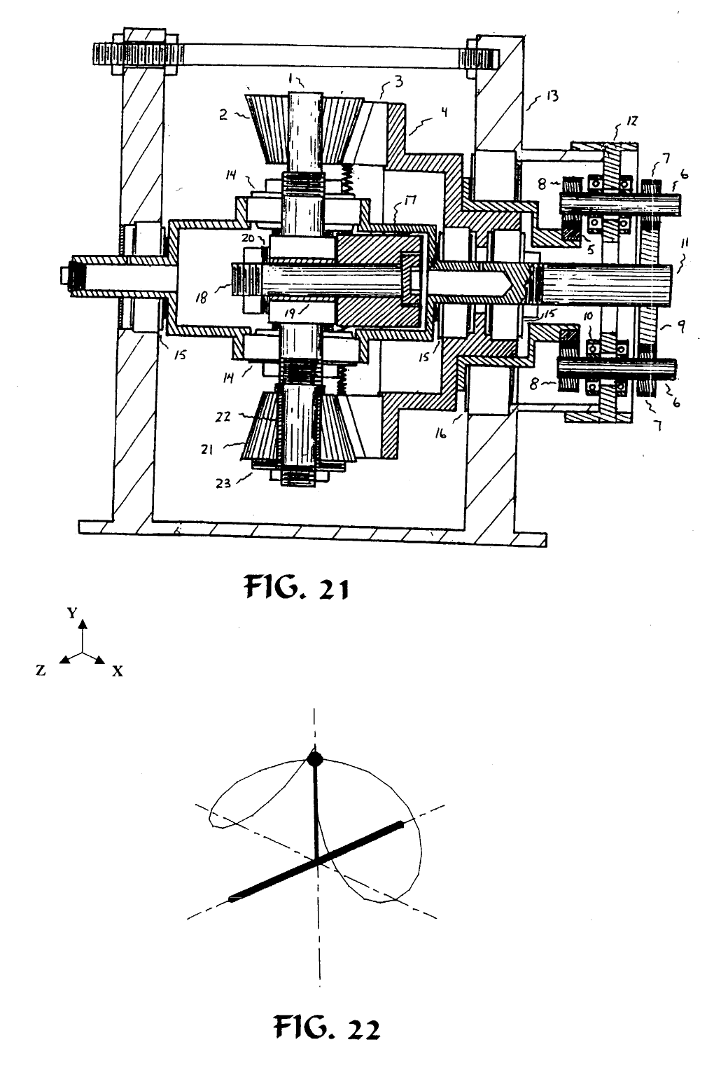

FIG. 21 is a cross-sectional view of a mechanical embodiment of the invention that relies on gearing to rotate a mass 17 in three dimensions, i.e., around two axes, and that corresponds to the test module described above. It will of course be appreciated that the embodiment illustrated in FIG. 21 is not intended to be limiting, and that any source of rotational power may be used to rotate the mass in three dimensions, including separate electronically synchronized motors or engines for each axis of rotation.

In the illustrated embodiment, mass 17 is supported by a rotor 1, which in turn is supported by rotor carrier 11 for rotation about an axis of rotation that is perpendicular to the axis of rotation of rotor 1 within rotor carrier 11. To this end, rotor 1 includes a bevel gear 2 secured thereto at one end. Bevel gear 2 meshes with mating ring gear 3. Ring gear 3 is fixedly secured to ring gear carrier 4. Carrier spur gear 5 is also attached to gear carrier 4 and meshes with two identical counter-rotating shafts 6 which have spur gears 7 and 8. Spur gears 7 mesh with carrier spur gear 9, which is attached to rotor carrier 11. Counter rotating shafts 6 rotate in low friction bearings 10 which are attached to counter shaft carrier 12. Counter shaft carrier 12 has an axial location means to position it with respect to bearing bracket 13, but is rotatable with respect thereto, while rotor carrier 11 supports and locates rotor 1 through low friction tapered roller bearings 14.

The rotor carrier itself is supported and rotates on tapered roller bearings 15, one of which is located on the bearing bracket 13 at the drive end, and two of which are located on the ring gear carrier 4. The ring gear carrier is supported and rotates within ring gear carrier bearing 16, which is also a tapered roller type bearing and is located in the bearing bracket 13.

Mass 17 is attached to rotor 1 by a shoulder bolt 18 centered on the rotor centerline, and is in turn centered on the rotor carrier centerline. It is supported by a low friction radial bearing 19 attached to the rotor 1, and by a low friction thrust bearing 20. Bevel gear 21 is similar to bevel gear 2, and meshes with ring gear 3. Bevel gear 21, unlike bevel gear 2, is free to rotate with respect to rotor 1 through radial bearing 22 and thrust bearing 23. In other words, the torque transmission to the rotor is through bevel gear 2 only. The bearing bracket is attached to the vehicle for transmission of the resulting forces produced.

The unique orbit of the mass 17, illustrated in FIG. 22, is a result of spinning or rotating the rotor 1 and rotor carrier 11 at identical angular velocities. This is accomplished in the mechanical embodiment through bevel gear 2, ring gear 3, carrier spur gear 5, rotor carrier gear 11, and counter shaft spur gears 7 and 8. For this particular embodiment, bevel gear 2 has 15 teeth, ring gear 3 has 45 teeth, carrier spur gear 5 has 45 teeth, rotor carrier gear 9 has 40 teeth, spur gear 8 has 15 teeth, and spur gear 7 has 20 teeth. When a rotational motion and torque is applied to the rotor carrier 11, the rotor carrier is advanced one revolution while the ring gear carrier is advanced only ⅔ of a revolution through the gear arrangement.

The torque necessary to rotate rotor 1 and rotor carrier 11 can be applied through any existing forms of prime movers, including electric motors, internal combustion engines, steam/gas turbines, and so forth, and even a crank or pedal, and in either a clockwise or counterclockwise direction, so long as one revolution of the rotor 1 is produced for every revolution of the rotor carrier 11 to produce the dual-axis orbit described above.

The motion of mass 17 in this embodiment of the invention, and specifically the centrifugal force vectors produced by the three dimensional orbit are described by equations 10, 11, and 12, described above, for the X, Y, and Z directions, respectively. The Y direction force is uni-directional even though the mass follows a planar, circular path around the rotor, and the rotor also rotates in two dimensions around an axis perpendicular to the rotor axis. Since the centrifugal force is a function of the rotational speed squared, the magnitude of the resulting unidirectional force can be controlled by controlling the input speed to the rotor carrier, while the direction of the force can be controlled by controlling the orientation of the rotor carrier.

d. Vibration Reducing Embodiment

Operation of the illustrated gear-driven mechanical embodiment will result in vibration in the X and Z directions caused by the sinusoidal forces in those directions. Although the vibrations do not affect the net force output of the system of the invention, and the Inventor has tested a prototype with these inherent vibrations, as described above it would be desirable to make operation smoother from the standpoint of a traveler in the vehicle.

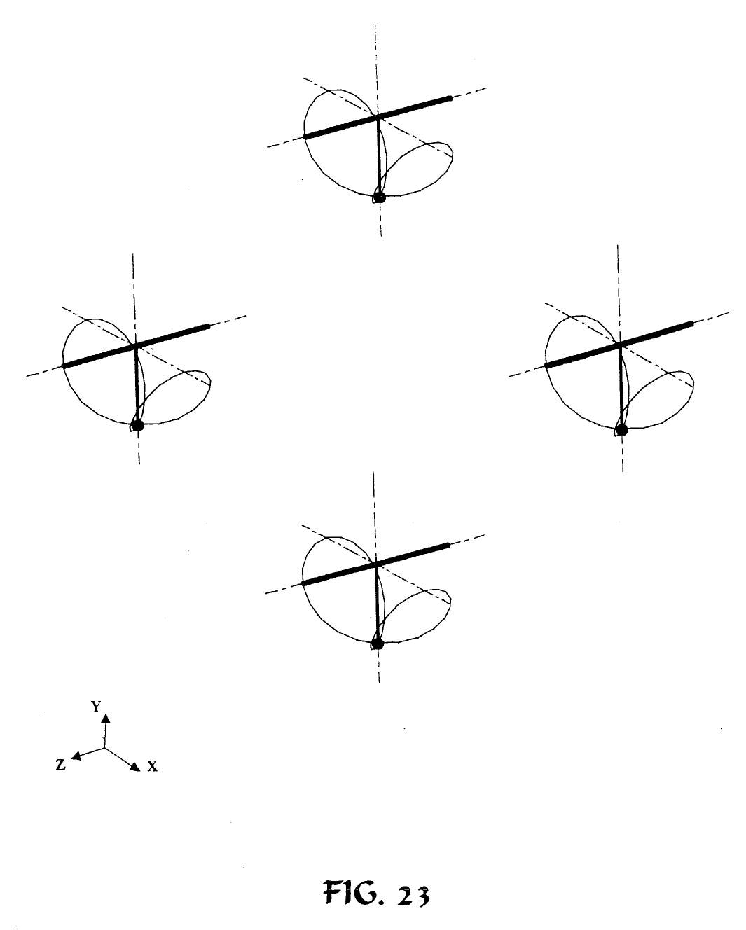

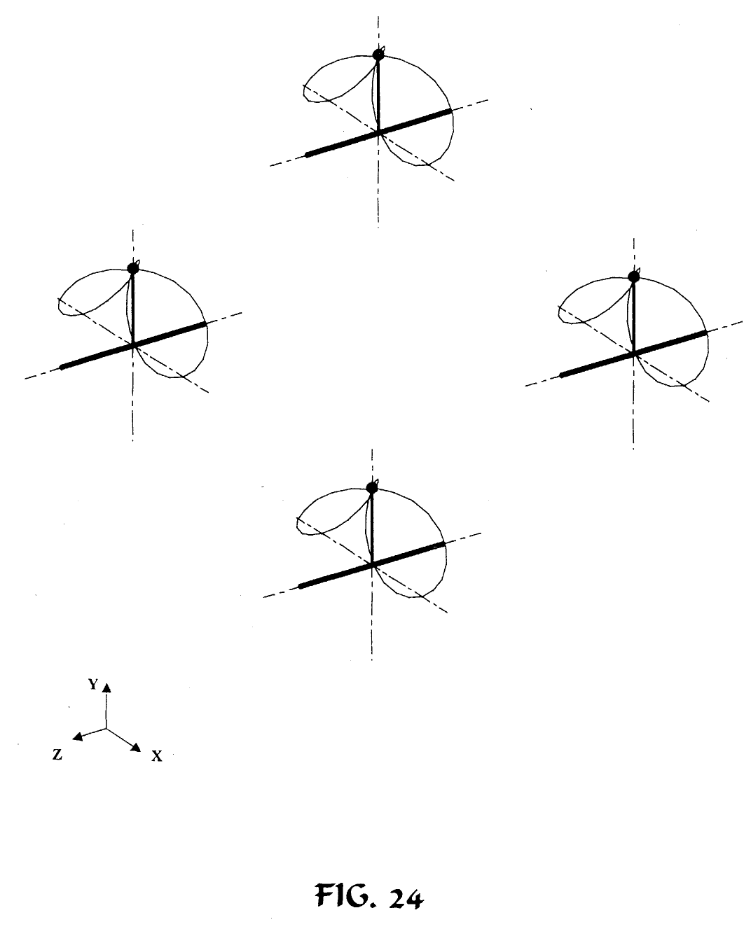

This could be accomplished, for example, by arranging and orienting four double-rotation units in a cluster, as shown in FIGS. 23-25, and/or by mounting four units on the same rotor carrier to reduce the number of bearings and bearing loading. Two of the units are 180 degrees out of phase with respect to the other two units. These four units are then all synchronized to operate in this phase relationship either through gearing or synchronized motor drives to the respective input rotor carriers 11.

As can be seen from FIG. 24, the masses travel from point A to point B in each respective drive so that at any particular time, given that all the masses are equal and positioned at an equal fixed radius and same speed, the X and Z components cancel each other. This leaves only the Y unidirectional force from each drive. An additional advantage of this arrangement is that if all four drives are centered with respect to each other, so that their moments cancel out with respect to the vehicle to which they are attached.

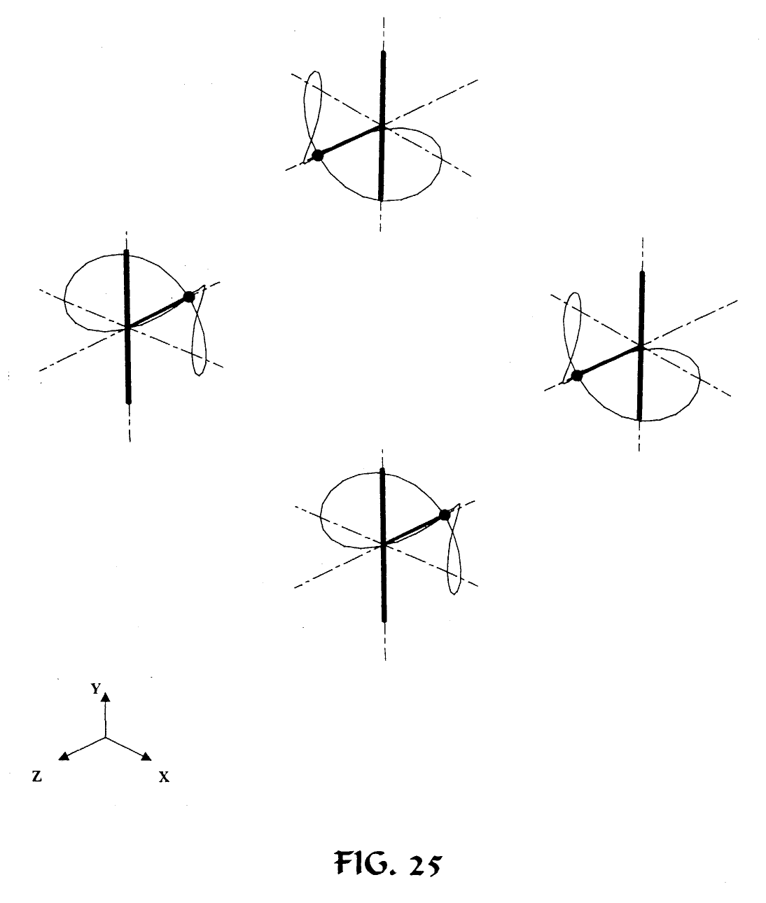

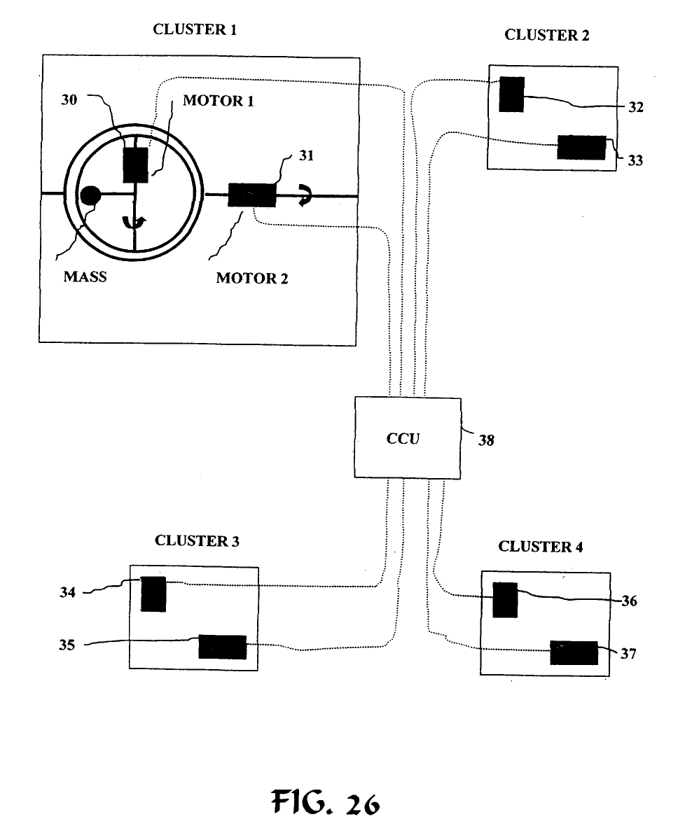

The four cluster arrangement not only reduces vibrations, but also provides a simple means of adjusting the direction and magnitude of the net centrifugal force, by causing the countershaft carrier 12 to be rotated on all four drives in a synchronized manner to adjust respective orbital phases. For example, the prototype unit's countershaft carrier can be turned 180 degrees while the unit is in operation and reverse the force output direction. Halfway travel of the countershaft carrier, that is 90 degrees, results in the orbit directions all canceling each other out as shown in FIG. 25, so that no resultant force is transferred to the vehicle from a four cluster arrangement.

As can be seen, the rotation of the countershaft carrier becomes a force directional controller without the need to vary the rotation speed of the masses. The speed of the rotor carrier establishes the maximum force level while rotation of the countershaft carriers control how much of that maximum force level the vehicle receives as well as the direction. Synchronization of the countershaft carriers is achieved through conventional gearing, or synchronized motor servos.

As in the embodiment of FIG. 21, synchronized rotation of the respective units in the four cluster system could be achieved by mechanical, electrical, electromagnetic, or other means of synchronization. For example, as shown in FIG. 26, each cluster could include two motors 30,31, 32,33, 34,35, and 36,37, one motor plus gearing, or combinations of one and two motors, with all of the motors being connected together and controlled by a central controller 38.

Having thus described preferred embodiments of the invention in sufficient detail to enable those skilled in the art to make and use the invention, it will nevertheless be appreciated that numerous variations and modifications of the illustrated embodiment may be made without departing from the spirit of the invention. For example, the principles of the invention are not necessarily limited to “vehicles” in the traditional sense, but rather may extend to any object requiring propulsion, including nano-scale objects, parts of larger machines, and even objects that merely rotate.

For example, as mentioned above, the propulsion system of the invention could be attached to the end of a torque arm, thereby applying a constant torque that only requires sufficient energy input to overcome resistance forces such as friction, and that can be used to drive a generator or even a larger dual-rotating propulsion system, resulting in even further energy savings than is possible with the embodiments described in detail above.

It is therefore intended that the invention not be limited by the above description or accompanying drawings, but that it be defined solely in accordance with the appended claims.

I claim:

1. A vehicle, comprising an impulse drive that propels the vehicle by a unidirectional centrifugal force generated by a rotating mass arranged to orbit two intersecting axes at predetermined radii and synchronized orbital periods, wherein momentum and energy are divided between the vehicle and the mass rather than expended by pushing on an external mass.

2. A vehicle as claimed in claim 1, wherein said radii and orbital periods of the mass around the two axes are identical.

3. A vehicle as claimed in claim 1, wherein the vehicle is a land vehicle.

4. A vehicle as claimed in claim 1, wherein the vehicle is a watercraft.

5. A vehicle as claimed in claim 1, wherein the vehicle is an aircraft.

6. A vehicle as claimed in claim 1, wherein the vehicle is a spacecraft, said spacecraft being propelled without exhausting mass in a direction opposite the direction of propulsion.

7. A vehicle as claimed in claim 1, wherein means for rotating the mass include at least one electric motor.

8. A vehicle as claimed in claim 1, wherein means for rotating the mass include at least one internal combustion engine.

9. A vehicle as claimed in claim 1, wherein rotation periods of the mass around the two axes are synchronized by mechanical gearing.

10. A vehicle as claimed in claim 1, wherein rotation periods of the mass around the two axes are synchronized electronically.

11. A vehicle as claimed in claim 1, wherein means for synchronizing the rotation periods of the mass around the two axes are electromagnetic.

12. A vehicle as claimed in claim 1, comprising four identical said rotating masses having identical rotation periods and radii with respect to corresponding pairs of intersecting axes, orientations of respective said corresponding pairs of intersecting axes being variable to vary the net centrifugal force and a direction of said net centrifugal force without varying said orbital periods.

13. A propulsion system for propelling an object in a predetermined direction, comprising:
a rotating mass fixed to the object, said mass being arranged to rotate around a first axis at a fixed radius, and said mass being further arranged to rotate around a second axis perpendicular to the first axis, wherein a rotation period of the mass around the first axis is identical to a rotation period of the mass around the second axis to generate a unidirectional net centrifugal force that pulls the object in said direction.

14. An impulse force propulsion drive, comprising:
a rotating mass attached to a first rotation means, said mass being located a predetermined nonzero distance away from a rotation center of the rotating means to thereby generate a centrifugal force in a first dimensional frame when rotated;
a second rotating means attached to the first rotating means and arranged to rotate said first rotating means around an axis transverse to a rotation axis of the first rotating means to generate an additional centrifugal force in a second dimensional frame;
synchronizing means for causing said first and second rotating means to rotate at identical angular velocities, wherein by summing vectors of centrifugal forces generated in said first and second dimensional frames, a net unidirectional force is obtained;
means for varying the identical angular velocities of said first and second rotating means to regulate an amount of force generated;
means for controlling an angular displacement between said first and second rotating means to control a direction of said unidirectional force;
means for attaching the drive first and second rotating means to a vehicle to utilize the unidirectional force to propel the vehicle in a third dimensional frame.

15. An impulse force propulsion drive as claimed in claim 14, wherein orientation and rotation direction phasing are varied to cancel sinusoidal forces in said two of said dimensional frames.

16. An impulse force propulsion drive as claimed in claim 14, wherein the mass and rotating means are connected by anti-friction bearings.

17. An impulse force propulsion drive as claimed in claim 14, wherein the synchronization means comprises mechanical gearing.

18. An impulse force propulsion drive as claimed in claim 14, wherein the rotation means include separate synchronized electric motors.

19. An impulse force propulsion drive as claimed in claim 14, comprising multiple said masses and corresponding rotation means, and wherein said angular displacement means are arranged to provide additional control of the net force level.

20. An impulse force propulsion drive as claimed in claim 14, further comprising means for attaching the drive to a torque arm and thereby convert the unidirectional force into rotation motion.
